(19) United States
(12) Patent Application Publication
(10) Pub. No.: US 2012/0307776 A1
(43) Pub. Date: Dec. 6, 2012

(54) BASE STATION RESOURCE ALLOCATION METHOD IN A WIRELESS COMMUNICATION SYSTEM AND A DEVICE FOR THE SAME

(75) Inventors: Sungkwon Hong, Seoul (KR); Kibum Kwon, Seoul (KR); Sungjin Suh, Seoul (KR)

(73) Assignee: PANTECH CO., LTD., Seoul (KR)

(21) Appl. No.: 13/578,233

(22) PCT Filed: Feb. 11, 2011
(86) PCT No.: PCT/KR2011/000958

§ 371 Date: Aug. 9, 2012

(30) Foreign Application Priority Data
Feb. 11, 2010 (KR) 10-2010-0013070

(51) Int. Cl. H04W 72/04

(52) U.S. Cl. 370/329

(57) ABSTRACT

The present invention relates to a resource allocation method in a wireless communication system, and to a device for the same.

### CROSS-REFERENCE TO RELATED APPLICATIONS

This application is the National Stage Entry of International Application No. PCT/KR2011/000958, filed on Feb. 11, 2011 and claims priority from and the benefit of Korean Patent Application No. 10-2010-0013070, filed on Feb. 11, 2010, all of which are hereby incorporated by reference for all purposes as if fully set forth herein.

### BACKGROUND

1. Field

The present invention relates to a method and apparatus for allocating resources in a wireless communication system.

2. Discussion of the Background

In a wireless communication system, one of the fundamental principles for radio access may be a shared channel transmission, that is, dynamical sharing of time-frequency resources among user equipments (UEs). A base station (BS) may control allocation of uplink (UL) and downlink (DL) resources.

### SUMMARY

Therefore, the present invention has been made in view of the above-mentioned problems, and an aspect of the present invention is to provide a method and apparatus for improving detailed resource allocation in a wireless communication system, and a system thereof.

In accordance with an aspect of the present invention, there is provided a method for a base station (BS) to allocate resources, the method including: allocating resources to one or more user equipments (UEs) in a wireless communication system; and generating a message that expresses, in a single resource allocation field, resource allocation to the one or more UEs through use of one of the two or more different resource allocation schemes when the resource allocation is performed, and that expresses the resource allocation scheme in a portion of the resource allocation field or in a region excluding the resource allocation field.

In accordance with another aspect of the present invention, there is provided a resource allocation apparatus, the apparatus including: a scheduler to allocate resources to one or more user equipments (UEs); a message generating unit to generate a message that expresses, in a single resource allocation field, resource allocation to the one or more UEs through use of one of the two or more different resource allocation schemes, and that expresses the resource allocation scheme in a portion of the resource allocation field or a region excluding the resource allocation field; and a message transmitting unit to transmit the message generated by the message generating unit.

In accordance with another aspect of the present invention, there is provided a resource allocation receiving apparatus, the apparatus including: a message receiving unit to receive a wirelessly transmitted message that expresses, in a single resource allocation field, resource allocation to the one or more UEs through use of one of the two or more different resource allocation schemes when the resource allocation is performed, and that expresses the resource allocation scheme in a portion of the resource allocation field or a region excluding the resource allocation field; a message interpretation unit to interpret the message based on a format of the message so as to obtain contents of the message; and a data transmitting unit to transmit data in an uplink (UL) based on information associated with UL scheduling obtained through the message interpretation unit when UL data transmission is performed.

### BRIEF DESCRIPTION OF THE DRAWINGS

FIG. 1 is a block diagram illustrating a wireless communication system according to an embodiment of the present invention;

FIG. 2 is a flowchart illustrating a method for a base station (BS) to allocate resources in a wireless communication system according to an embodiment of the present invention;

FIG. 3 is a diagram illustrating a method of expressing a resource allocation scheme according to another embodiment of the present invention;

FIG. 4 is a diagram illustrating an example that applies the method of expressing the resource allocation scheme of FIG. 3 to an LTE system;

FIG. 5 is a conceptual diagram illustrating a method of expressing a resource allocation scheme according to another embodiment of the present invention;

FIG. 6 is a diagram illustrating an example that applies the method of expressing the resource allocation scheme of FIG. 5 to an LTE system;

FIGS. 7 and 8 are conceptual diagrams illustrating a method of expressing frequency hopping (FH) or another use in a residual region of a resource allocation field;

FIG. 9 is a flowchart illustrating a resource allocation method according to another embodiment of the present invention;

FIG. 10 is a block diagram illustrating a wireless communication system according to another embodiment of the present invention;

FIG. 11 is a flowchart illustrating a configuration of a PDCCH according to another embodiment of the present invention;

FIG. 12 is a block diagram illustrating a BS that generates control information of a downlink (DL) according to another embodiment of the present invention;

FIG. 13 is a flowchart illustrating PDCCH processing; and

FIG. 14 is a block diagram illustrating a user equipment (UE) according to another embodiment of the present invention.

### DETAILED DESCRIPTION OF THE ILLUSTRATED EMBODIMENT

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

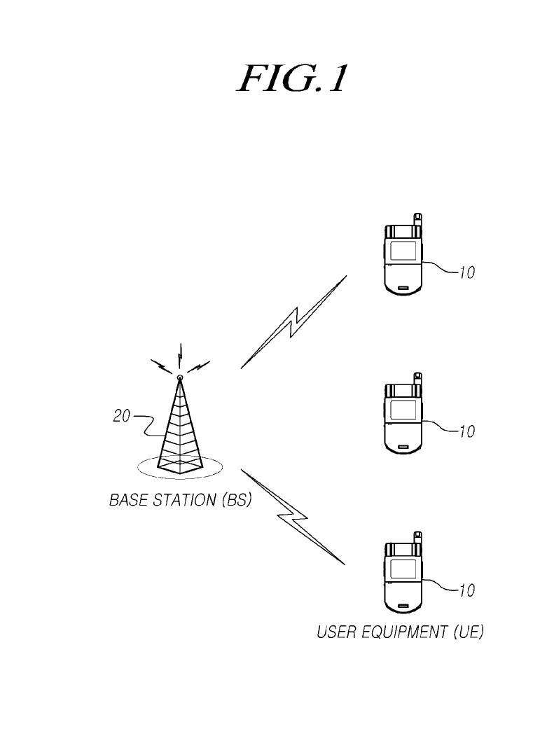

FIG. 1 illustrates a wireless communication system according to an embodiment of the present invention.

The wireless communication system may be widely installed so as to provide various communication services, such as a voice service, a packet data service, and the like.

Referring to FIG. 1, the wireless communication system may include a user equipment (UE) 10 and a base station (BS) 20. The UE 10 and the BS 20 may use varied power allocation methods to be described in the following embodiments.

Throughout the specifications, the UE 10 may be an inclusive concept indicating a user terminal utilized in radio communication, including a UE in wideband code division multiple access (WCDMA), long term evolution (LTE), High Speed Packet Access (HSPA), and the like, and a mobile station (MS), a user terminal (UT), a subscriber station (SS), a wireless device, and the like in GSM.

The BS 20 or a cell may refer to all devices, a function, or a predetermined area associated with communication with the UE 10, and may also be referred to as a Node-B, an evolved Node-B (eNB), a sector, a site, a base transceiver system (BTS), an access point, a relay node, and the like.

The BS 20 or the cell may be construed as an inclusive concept indicating a function or a portion of an area covered by a base station controller (BSC) in CDMA, a NodeB in WCDMA, an eNB or a sector (site) in LTE, and the like and the concept may include various coverage areas, such as a megacell, a macrocell, a microcell, a picocell, a femtocell, a relay node, and the like.

In the specifications, the UE 10 and the BS 20 are used as two inclusive transceiving subjects to embody the technology or technical concepts described in the specifications, and may not be limited to a predetermined term or word.

A multiple access scheme applied to the wireless communication system may not be limited. The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), Orthogonal Frequency Division Multiple Frequency Division Multiple Access (OFDMFDMA), Orthogonal Frequency Division Multiple Time Division multiple access (OFDMTDMA), Orthogonal Frequency Division Multiple Code Division Multiple Access (OFDMCDMA), and the like.

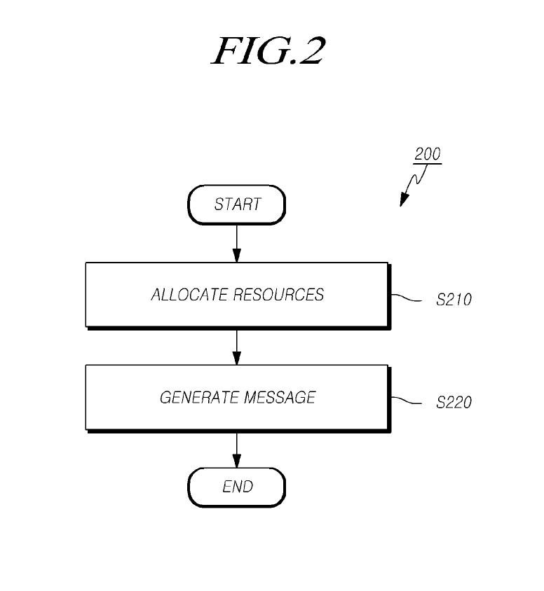

FIG. 2 illustrates a method for a BS to allocate resources in a wireless communication system according to an embodiment of the present invention.

Referring to FIG. 2, in the wireless communication system, a resource allocation method 200 for the BS may include an operation of allocating resources to a predetermined UE (step S210), and an operation of generating a message that expresses, in a single resource allocation field, resource allocation to one or more UEs through use of two or more different resource allocation schemes during the resource allocation, and that expresses the resource allocation scheme in a portion of the resource allocation field or a region excluding the resource allocation field (step S220).

In this example, the resource allocation scheme may be one of a bitmap format-based resource allocation scheme, a periodic resource allocation scheme, a resource allocation scheme that expresses the resource allocation based on a length and an offset associated with a resource allocation region, and an independent resource allocation scheme.

For example, resource allocation may be expressed in the message in a bitmap format, or may be expressed in the message based on a length and an offset associated with the resource allocation region.

In this example, the resource allocation scheme that expresses the resource allocation may or may not be expressed in the message. When the resource allocation scheme is expressed, the resource allocation scheme may be expressed in a region excluding the resource allocation field or in a portion of the resource allocation field.

In an LTE system which is one of the wireless communication systems, data transmitted from the UE 10 to the BS 20 in a UL may be included in a set of resource blocks (RBs) or a set of resource block groups (RBGs), designated by resource allocation determined by the BS 20, for transmission. The BS 20 may inform the UE 10 of this through use of a DCI format of a physical downlink control channel (PDCCH) corresponding to a control channel of a DL. This process may be referred to as UL scheduling grant or PUSCH grant.

A predetermined field of the DCI format may inform the UE 10 of a predetermined region in a UL frame format in which the UE 10 needs to include the data for transmission, and the region may be referred to as a resource allocation field. Resource allocation expressed by the resource allocation field may be processed based on an RB set unit, such as an RB or an RBG. Information associated with the resource allocation may be expressed in binary values within a predetermined range through use of varied formats in the resource allocation field, so that the UE 10 may be informed of contents of the resource allocation.

The UE 10, which is a receiving side, may interpret the detected resource allocation field in a PDCCH DCI format. The UE 10 may interpret the resource allocation field, that is, may allocate resources of a PUSCH, so as to transmit data to the BS 20.

Although the resource allocation method has been described based on the LTE system which is one of the wireless communication systems, embodiments of the present invention may not be limited thereto. Accordingly, a detailed resource allocation scheme or a configuration thereof may not be limited to the LTE system. Also, although the embodiments of the present invention may be described in terms of a UL, the embodiments of the present invention may be equivalently applicable to a DL, and may need to be construed based on resource allocation schemes or configurations described in the specifications.

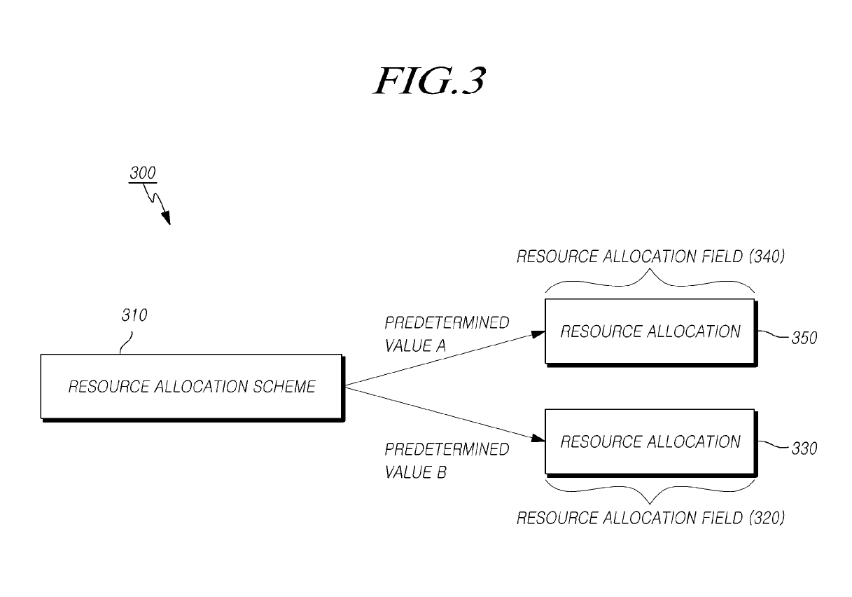

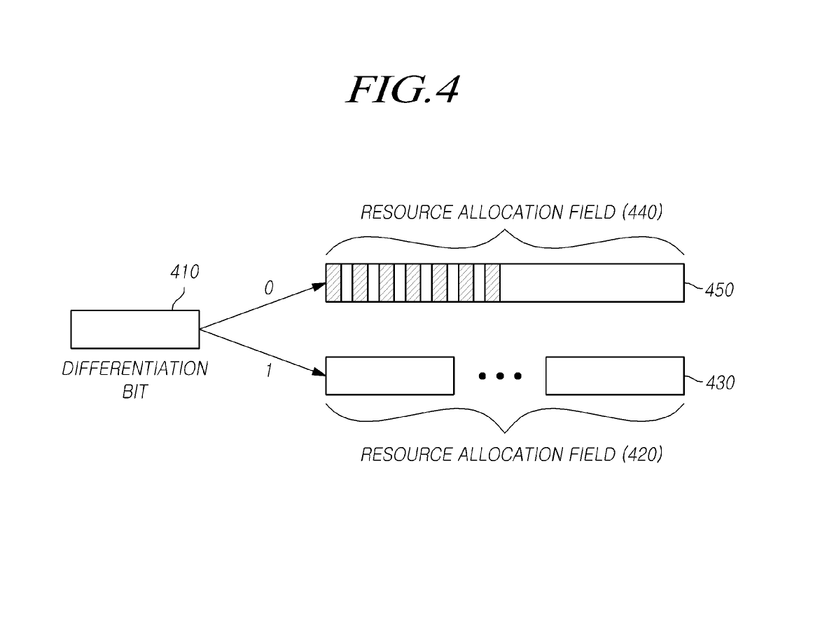

The resource allocation method has been inclusively described in the foregoing. Hereinafter, a method of expressing a resource allocation scheme in a region excluding a resource allocation field will be described with reference to FIGS. 3 and 4.

FIG. 3 illustrates a method of expressing a resource allocation scheme according to another embodiment of the present invention.

Referring to FIG. 3, the resource allocation scheme may be expressed in a region excluding a resource allocation field in a message 300, that is, a resource differentiation field 310, and resource allocation may be expressed in the entirety 330 and 350 of a resource allocation field 320 and 340 based on the resource allocation scheme. The resource allocation scheme may be expressed by adding a predetermined value (for example A or B) to the resource differentiation field 310.

For example, when the predetermined value is “A”, the resource allocation scheme may be one of a bitmap format-based resource allocation scheme, a periodic resource allocation scheme, and a resource allocation scheme based on a length and an offset. When the predetermined value is “B”, the resource allocation scheme may be an independent resource allocation scheme.

In this example, the bitmap format-based resource allocation scheme, the periodic resource allocation scheme, and the resource allocation scheme based on a length and an offset may correspond to type 0, type 1, and type 2, respectively, from among resource allocation schemes used in the LTE system that is one of the wireless communication systems. To describe the resource allocation schemes, the LTE system will be described.

In LTE, control information for UL and DL communication and resource allocation information to be allocated to each UE in frequency and time resources may be transferred through a physical downlink control channel (PDCCH) that is transmitted in a DL. A resource region may be formed based on a time-frequency unit of an RB. In a case of a broadband, a number of RBs increases and an amount of bits required for indicating resource allocation information may also increase and thus, a few RBs may be combined and processed as an RBG. The resource allocation information expressed based on an RB or an RBG may be transmitted through use of a resource allocation field in the PDCCH. Bandwidths used in LTE may be 1.4/3/5/10/15/20 MHz. When the bandwidths are expressed based on a number of RBs, the bandwidths may correspond to 6/15/25/50/75/100, respectively. Sizes (P) of RBGs expressed by corresponding RBs in the respective bands may be 1/2/2/3/4/4, respectively. Therefore, a number of RBGs for each band may be 6/8/13/17/19/25.

As described in the foregoing, resource allocation schemes used in the LTE system may include resource allocation type 0 (type 0), resource allocation type 1 (type 1), and resource allocation type 2 (type 2).

Type 0 may indicate a resource allocation region based on a bitmap format. That is, resource allocation may be expressed to be 1, and non-resource allocation may be expressed to be 0 for each RBG, so as to indicate resource allocation with respect to the entire band. When a number of RBs is n, an amount of bits required for expressing resource allocation based on type 0 may be

$$⌈ \frac{n}{P} ⌉ .$$

In this example, p denotes a number of RBs forming an RBG.

Type 1 indicates a resource allocation region based on a periodic format. That is, type 1 may indicate resource allocation having a period of P and in a form of distributions at regular intervals in the entire allocation region. Type 1 may be designed to use the same amount of bits as type 0 by setting ┌ log₂(P)┐ bits to indicate a size of a subset having the period, setting 1 bit to indicate an offset, and setting

$$⌈ \frac{n}{P} ⌉ - ⌈ {log}_{2} ( P ) ⌉ - 1$$

to indicate predetermined resource allocation. In general, when type 0 and type 1 are used together, a differentiation bit to distinguish type 0 and type 1 may be added.

Type 2 may be used to allocate a contiguous resource region having a predetermined length. This may be expressed based on an offset at a starting point of the entire resource allocation region and a length of the resource allocation region. Unlike type 0 and type 1 that indicate noncontiguous resource allocation, type 2 may indicate and require a contiguous resource region and thus, an amount of bits required may be less than type 0 and type 1 when a large number of RBs is used in a system that uses a wide band. The amount of bits required may be

$$⌈ {log}_{2} \frac{n ( n + 1 )}{2} ⌉ .$$

Therefore, other resource allocation schemes may express resource allocation based on an RBG format, whereas type 2 may express the resource allocation based on an RB format.

There may be various PDCCH formats in LTE, and each format may be changed based on an MIMO transmission scheme, a channel estimation scheme, and the like. Also, an applicable format may be changed based on a transmission mode. The format may be referred to as a downlink control information (DCI) format, and types of the DCI formats may include DCI format 0/1/1A/1B/1C/1D/2/2A/3/3A. A different resource allocation scheme may be used for each DCI format.

For example, DCI format 1 may indicate control information associated with a physical downlink shared channel (PDSCH) having a single codeword, and DCI format 1A may indicate compressed PDSCH control information. DCI format 1 and DCI format 1A may transmit the same information excluding resource allocation information. DCI format 1 may use the type 0 scheme and DCI format 1A may use the type 2 scheme. DCI format 2 may transmit control information for closed loop MIMO operation, and may have a resource allocation scheme of type 0. DCI format 1 may have DCI format 1A that transmits the same information as DCI format 1 and that uses type 2 as a resource allocation scheme, whereas DCI format 2 may not have a corresponding format.

FIG. 4 illustrates an example that applies the method of expressing the resource allocation scheme of FIG. 3 to an LTE system.

Referring to FIG. 4, in a case where the LTE system is used as a wireless communication system, when a differentiation bit 410 that expresses a corresponding resource allocation scheme in the region 310 excluding the resource allocation field of FIG. 3 is “0”, type 0 may be used as a resource allocation scheme. When the differentiation bit 410 is “1”, type 1 may be used as the resource allocation scheme. Resource allocation may be expressed in the entirety 430 and 450 of a resource allocation field 420 and 440 of a message 400, based on a corresponding resource allocation scheme.

When the differentiation bit 410 is “0”, resource allocation may be expressed to be 1 and non-resource allocation may be expressed to be 0 for each RBG in the resource allocation field 440, based on the corresponding resource allocation scheme. For example, when a bandwidth is 20 MHz, a number of RBs is 100, and a size (P) of an RBG expressed by RBs corresponding to the bandwidth is 4, a number of RBs of each band is 25.

Therefore, when the differentiation bit 410 is “0”, resource allocation may be expressed to be 1 and non-resource allocation may be expressed to be 0 for each of 25 RBGs in the resource allocation field 440 of 25 bits, so that resource allocation with respect to the entire band may be expressed. Conversely, when the differentiation bit 410 is “1”, one of the types used in the LTE system or different independent resource allocation scheme may be used in the resource allocation field 420.

When the differentiation bit 410 is “1”, a method of expressing resource allocation in the resource allocation field 420 based on the different independent resource allocation scheme may be as follows.

As an example of the independent resource allocation scheme, the resource allocation type 2 (a resource allocation scheme having one cluster) of which a size of an RBG is smaller (P′<P) may be used. In this example, when p′=1 with respect to the independent resource allocation scheme and

$$⌈ {log}_{2} \frac{100 ( 100 + 1 )}{2} ⌉ = 5050 = 13$$

bits are allocated, resolution for detailed scheduling may be provided for a contiguous resource allocation scheme having one cluster. According to type 0 which is another resource allocation scheme of the differentiation bit, less detailed scheduling of which P=4 may be provided but a higher resolution may be provided.

When type 2 is used as the independent resource allocation scheme, a control field that indicates information associated with resource allocation that the BS 20 informs the UE 10 of, for example, a resource allocation field, may express an available resource allocation case through use of an integer value within a predetermined range. A case that expresses the available resource allocation case through use of the integer value within the predetermined range may be referred to as a resource indication value (RIV). A method of expressing resource allocation in the resource allocation field through use of the RIV by using type 2 as the independent resource allocation scheme will be described in detail with reference to Equations 1 and 2.

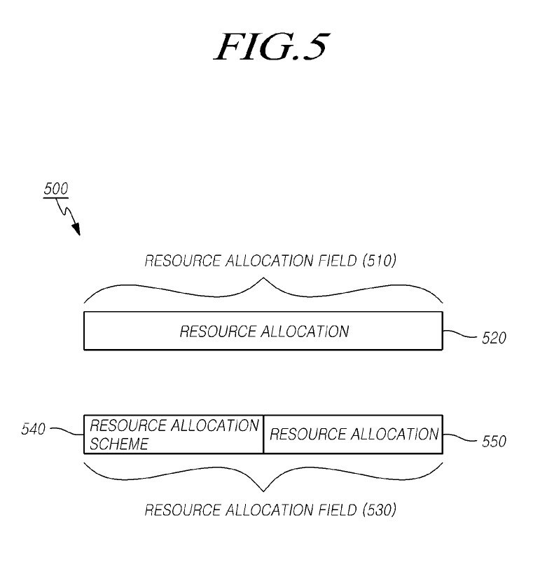

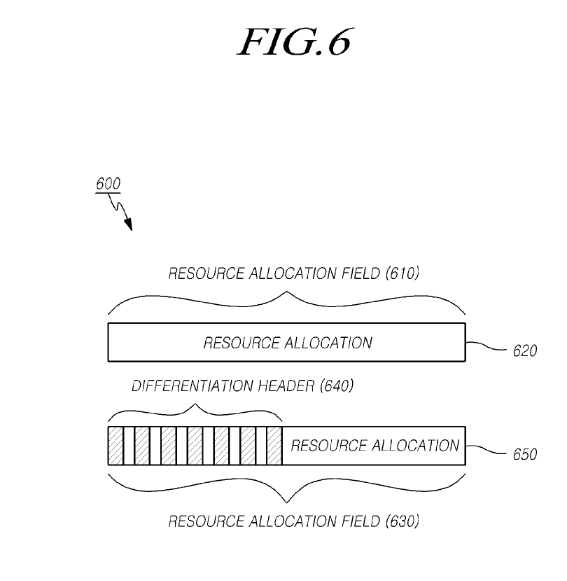

The method of expressing the resource allocation scheme in a region excluding the resource allocation field has been described. Hereinafter, a method of expressing a resource allocation scheme in a portion of a resource allocation field with reference to FIGS. 5 and 6 will be described.

FIG. 5 illustrates a method of expressing a resource allocation scheme according to another embodiment of the present invention.

Referring to FIG. 5, when resource allocation is expressed in a message without expressing a resource allocation scheme, the resource allocation may be expressed in the entirety 520 of the resource allocation field 510 as shown in the top of FIG. 5.

Conversely, when the resource allocation scheme is expressed in the same message 500, a portion 540 of a resource allocation field 530 may express the resource allocation scheme, and another portion 550 may express the resource allocation.

FIG. 6 illustrates an example that applies the method of expressing the resource allocation scheme of FIG. 5 to an LTE system.

Referring to FIG. 6, the method of expressing the resource allocation scheme may distinguish the resource allocation scheme based on a predetermined differentiation header or a differentiation pattern, without using a separate differentiation bit.

When the resource allocation scheme is not expressed in a message 600, and resource allocation is expressed based on the resource allocation scheme, the resource allocation may be expressed in the entirety 620 of a resource allocation field 610, as shown in the top of FIG. 6. For example, when a number of clusters is in a range from J (a natural number greater than or equal to 2) to K (a natural number greater than or equal to 2 and greater than J), resource allocation may be expressed in J through K clusters of the entire of the resource allocation field 610 based on an RBG unit according to the Type 0 scheme.

According to the type 0 resource allocation scheme, as a maximum number of clusters increases, improvement in performance obtained by resource allocation tends to be saturated. For example, when the number of clusters is at least K+1, the improvement in performance obtained by the resource allocation tends to be saturated. Due to the tendency, although a maximum number of clusters is limited, a number of clusters that provides a meager performance value and is abandoned may exist. According to the type 0 resource allocation scheme, the maximum number of clusters is limited, and an encoding format of another resource allocation scheme to be combined is encoded to have a greater number of clusters than the maximum number of clusters and thus, they are distinguished from each other.

Conversely, when the resource allocation scheme is expressed in the same message 600 and the resource allocation is expressed based on the resource allocation scheme, the resource allocation scheme may be expressed in a portion 640 of the entire resource allocation field 630, and the resource allocation may be expressed in another portion 650 of the resource allocation field 630, as shown in the bottom of FIG. 6.

For example, in the bottom of FIG. 6, when the maximum number of clusters is limited to K, for example, 6, and a differentiation header or a differentiation pattern is expressed by 11 bits of 10101010101, and an independent resource allocation scheme in a different format may be expressed by 14 bits corresponding to the remaining portion. That is, when the number of clusters is greater than or equal to K+1, improvement in performance obtained by the resource allocation may be meager and 11 bits of 10101010101 may indicate the differentiation header and 14 bits of the remaining portion may indicate other values and thus, resource allocation may be expressed based on an independent resource allocation scheme that is different from type 0 through type 2.

1) The differentiation header or the differentiation pattern 640 may start from 1, and is formed by repeating 01 until a number of 1 is equal to the maximum number of clusters. When the maximum number of clusters expressed based on type 0 is K, 2×K−1 bits may be required. The differentiation bit or the differentiation header may be a pattern or a bit to be used for differentiation, may be distributed in any of the entire resource allocation region, and may be distributed based on a bit unit. Also, a portion of all of the bits may be residual reserved bits in a PDCCH as opposed to the resource allocation region.

2) The remaining portion 650 indicating the independent resource allocation scheme may be indexed from 1. That is, indexing may be performed by adding 1 to the resource allocation information that starts from 0. Also, remaining portion 650 may have a different P′ value. Accordingly, the independent resource allocation scheme may be expressed by K+1 or more clusters.

3) As an example of the independent resource allocation scheme, a resource allocation scheme that has a range of a number of clusters may be used as the independent resource allocation scheme. In consideration of a resource allocation scheme that may be available in the current LTE system, type 2 may be available.

For example, a resource allocation scheme that has a smaller RBG (P′<P) and has a range of a number of clusters from 1 up to K′ (K′<K) may be used as the independent resource allocation scheme. In this example, a resource allocation scheme that indicates from one cluster up to K′ clusters may be considered. A resource allocation scheme that indicates from K′+1 clusters to K clusters may use type 0, and a resource allocation scheme that indicates from one cluster up to K′ clusters may use the independent resource allocation scheme. That is, in transmission mode 4, DCI format 2 may include resource allocation information of type 2 and may not have a format that provides detailed scheduling during a blind decoding process. Accordingly, DCI format 2 may obtain improvement in performance through resource allocation with respect to one cluster or successive blocks.

A resource allocation scheme that has a smaller RBG (P<P′), and has a range of a number of clusters from 2 up to K′ may be used as the independent resource allocation scheme. In this example, a resource allocation scheme that indicates from 2 clusters up to K′ clusters may be considered. A resource allocation scheme that indicates from K′+1 to K clusters may use type 0, and the resource allocation scheme that indicates from 2 clusters up to K′ clusters may use the independent resource allocation scheme. With respect to one cluster, that is, a contiguous resource allocation scheme, detailed resource allocation may be available through a different DCI format.

That is, in transmission mode 1, 2, or 7, DCI format is distinguished through a blind decoding process, like DCI format 0 and 1A, and DCI format 1A is more effective when resource allocation with respect to one cluster is required and thus, resource allocation may not need to be defined for DCI format 1. Performance may be improved by providing detailed scheduling to 2 through K′ clusters. When type 2 is used as the independent resource allocation scheme, a control field that indicates information associated with resource allocation that the BS 20 informs the UE 10 of, for example, a resource allocation field, may express an available resource allocation case through use of an integer value within a predetermined range. A case that expresses the available resource allocation case through use of the integer value within the predetermined range may be referred to as a resource indication value (RIV). Hereinafter, the information field that is used when the BS 20 informs the UE 10 of the information associated with the resource allocation may be referred to as the resource allocation field, and the integer value within the predetermined range may be referred to as an RIV, but this may not be limited thereto.

When the entire resources are formed of n RBs or RBGs in a case of resource allocation in a UL, the BS 20 may allocate contiguous RBGs to the UE 10, or may allocate noncontiguous RBGs to the UE 10. In a case of noncontiguous resource allocation, each of contiguous resource allocation regions may be referred to as a cluster.

A resource allocation field of contiguous resource allocation may be formed of RIV_{LTE}(L_{CRBs}, RBₛₜₐᵣₜ, N_{RB}^{DL}) corresponding to a starting RB (RBₛₜₐᵣₜ) of an RBG and a length in terms of virtually contiguously allocated RBs (L_{CRBs}).

In this example, RIV_{LTE}(L_{CRBs}, RBₛₜₐᵣₜ, N_{RB}^{DL}) may be expressed as below.

if (L_{CRBs}−1)≦└N_{RB}^{DL}/2┘ then

RIV_{LTE}(L_{CRBs},RBₛₜₐᵣₜ,N_{RB}^{DL})=N_{RB}^{DL}(L_{CRBs}−1)+RBₛₜₐᵣₜ

else

RIV_{LTE}(L_{CRBs},RBₛₜₐᵣₜ,N_{RB}^{DL})=N_{RB}^{DL}(N_{RB}^{DL}−L_{CRBs}+1)+(N_{RB}^{DL}−1−RBₛₜₐᵣₜ) [Equation 1]

where L_{CRBs}≧1 and shall not exceed N_{VRB}^{DL}−RBₛₜₐᵣₜ.

Here, └•┘ denotes a floor function, and indicates the largest number from among integers that are less than or equal to a number in └ ┘. N_{VRB}^{DL} denotes a maximum length of a virtually connected RBG. N_{RB}^{DL} denotes a value indicating a number of the entire RBGs and corresponds to n. “DL” denotes a Downlink, but it may not be limited to a Downlink.

A resource allocation field of noncontiguous resource allocation may be formed of an RIV corresponding to a starting RB of the first cluster, an ending RB of the first cluster, a starting RB of the second cluster, and an ending RB of the second cluster.

Also, the resource allocation field of noncontiguous resource allocation may be formed of an RI corresponding to four offset values for two noncontiguous clusters.

Also, the resource allocation field of noncontiguous resource allocation may be formed of an RIV corresponding to an offset and a length of all RBGs in two clusters and the region of RBGs between two clusters, where resources are not allocated, and an offset and a length of the region of RBGs between the two clusters, where resources are not allocated.

Also, the resource allocation field of noncontiguous resource allocation may be formed of an RIV corresponding to an offset (y) and the entire length (x) of all RBGs in two clusters and in a region of RBGs to which resources are not allocated, and a starting point (w) and an end point (z) of the region between the two clusters, where the resources are not allocated. In this example, the starting point (w) and the end point (z) of the region between the two clusters, where the resources are not allocated, may be based on a starting RB of the all RBGs.

Also, the resource allocation field of noncontiguous resource allocation may be formed of an RIV corresponding to an offset (y) and the entire length (x) of all RBGs in two clusters and in a region of RBGs to which resources are not allocated, and a starting point (w) and an end point (z) of the region between the two clusters, where the resources are not allocated. In this example, the starting point (w) and the end point (z) of the region between the two clusters, where the resources are not allocated, may be based on a starting RB of RBGs of a first cluster.

The resource indicators of the resource allocation method of two or more noncontiguous clusters have been described, and a resource indicator of a resource allocation method of k noncontiguous clusters obtained will be described by generalizing the method described in the foregoing.

An RIV that expresses the k noncontiguous clusters may be configured to include two coefficients (an offset and a length) that indicate the entire region and k2 noncontiguous regions to which resources are not allocated among the entire region. The k2 noncontiguous regions to which resources are not allocated may be expressed by an RIV value indicating the k2 clusters, the RIV associated with the k clusters may be recursively obtained. In the recursive configuration of the RIV, the RIV of the k2 regions to which the resources are not allocated may be designated within a range smaller than the length indicating the entire region and thus, a starting point of each offset and a range of the length may be determined.

In addition to the noncontiguous resource configuration as described in the foregoing, various RIV configurations of noncontiguous resources may be available. Resource configuration may be expressed based on a general scheme that is different from the described scheme. That is, when resource allocation is expressed based on coefficients x₁, x₂, . . . , xₖ (expressed by k coefficients), a resource indicator RIV(x₁, x₂, . . . , xₖ, n) of a general resource allocation field used in the specifications may be expressed as follows.

RIV(x₁,x₂, . . . ,xₖ,n)=RIV₁(x₁,n)+RIV₂(x₁,x₂,n)+ . . . +RIVₖ(x₁,x₂, . . . ,xₖ,n) [Equation 2]

In Equation 2, each of x₁ and x₂, . . . , xₖ indicates at least one of an offset, a length of RBGs, and a starting point or an end point of a predetermined cluster, and n denotes a number of all the RBGs. Also, RIV₁(x₁, n) may be a function of x₁ and n, and may indicate a number of all combinations (under a condition of x₁=x₁^{fixed}) within an available range of each of coefficients of x₂, . . . , xₖ when it is fixedly determined that x₁=x₁^{fixed}, and RIV₂(x₁, x₂, n) may be a function of x₁, x₂, and n, and may indicate a number of all combinations (under a condition of x₁=x₁^{fixed} and x₂=x₂^{fixed}) within an available range of each of coefficients of x₃, . . . , xₖ when it is fixedly determined that x₁=x₁^{fixed} and x₂=x₂^{fixed}. Therefore, RIVᵢ(x₁, x₂, . . . , xᵢ, n) may be a function of x₁, x₂, . . . , xₖ, and n, and may indicate a number of all combinations (under a condition of x₁=x₁^{fixed}, x₂=x₂^{fixed}, . . . , and xᵢ=xᵢ^{fixed}) within an available range of each of coefficients of xᵢ₊₁, . . . , xₖ when it is fixedly determined that x₁=x₁^{fixed}, x₂=x₂^{fixed}, . . . , and xᵢ=xᵢ^{fixed}. Here, to start a value of RIV(x₁, x₂, . . . , xₖ, n) from 0, x=x^{fixed}−1 may be used, as opposed to x=x^{fixed}.

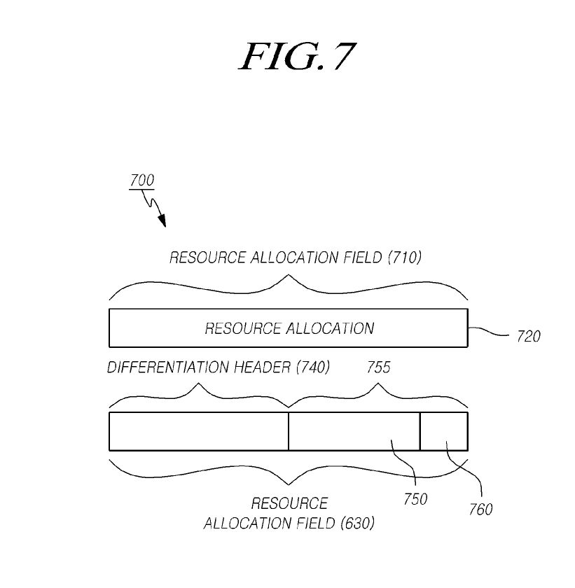

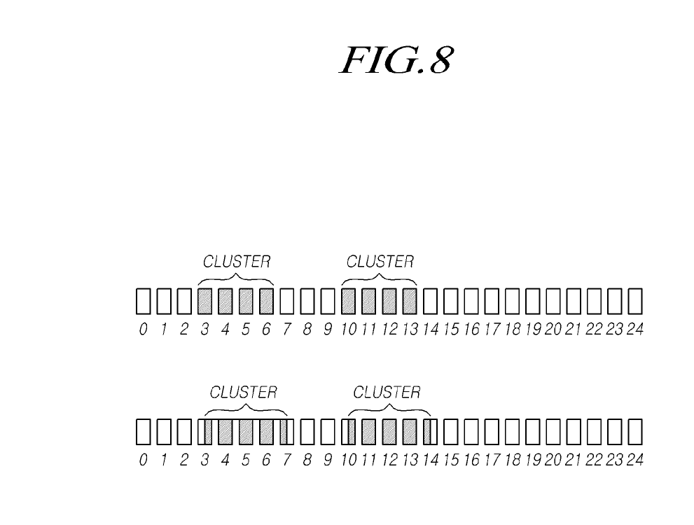

The method of expressing the resource allocation scheme in the portion of the resource allocation field has been described. Hereinafter, a method of expressing frequency hopping (FH) or another use in a residual region of the resource allocation field will be described with reference to FIGS. 7 and 8.

FIGS. 7 and 8 illustrate a method of expressing FH or another use in a residual region of a resource allocation field.

Referring to FIG. 7, when a remaining portion 755 includes a residual region or a residual bit 760 in addition to a region or a bit length 750 indicating an independent resource allocation scheme as shown in a differentiation bit of FIGS. 3 and 4, the bit may be utilized for another use. For example, when the residual bit 760 exists in the remaining portion 755 in addition to the bit length 750 indicating the independent resource allocation scheme, the residual bit may be used for expressing FH. A FH bit may determine whether to perform FH with respect to allocated resources.

When the maximum number of clusters is limited to K, for example, 6, and a differentiation header or a differentiation pattern 740 is expressed by 11 bits of 10101010101, 14 bits may remain. When type 2 is expressed in the remaining portion 755 as a resource allocation scheme and resource allocation is expressed with respect to 100 RBs,

$$⌈ {log}_{2} \frac{100 ( 100 + 1 )}{2} ⌉ = 5050 = 13$$

bits may be required and thus, remaining 1 bit 750 may be used for FH. However, when the remaining 1 bit 760 is not used for FH, it may be used for another use, for example, as an offset bit.

The offset bit may express that resource allocation is performed by shifting, by a predetermined offset, RBs or RBGs to which resources are to be allocated.

Referring to FIGS. 7 and 8, it is assumed that a resource allocation scheme is expressed by 11 bits of 10101010101 to be an independent resource allocation scheme, for example, type 2, as shown in the bottom of FIG. 7, and resources are allocated to two clusters formed of 3 through 6 RBGs and 10 through 13 RBGs, through use of 13 bits of a remaining portion as shown in the top of FIG. 8. In this example, when the bit (760 of FIG. 7) used for FH is used as an offset bit, resource allocation may be performed by shifting both or one of the two clusters by a predetermined range, for example, by ½ of RBG. In this example, the offset value, that is, the range of shifting, may be within a single RBG, or may be greater than the single RBG such as 2 RBGs.

Although a case in which the FH bit occupies a portion of the resource allocation field has been described, the embodiments of the present invention may not be limited thereto. The FH bit may separately exist in a location that is different from the resource allocation field. That is, although the FH bit is configured independently from the resource allocation, an offset of resource allocation may be expressed when a number of clusters is at least two (or predetermined K″) in the same manner as the previously described case.

In this example, in a case of resource allocation for a predetermined number or more of clusters, a FH bit may not be allocated and an offset that is within or beyond a size (P) of an RBG of noncontiguous cluster allocation may be indicated. FH may have a relative gain with respect to resource allocation by a contiguous resource allocation region and may not have a great performance gain with respect to a noncontiguous resource allocation region. Accordingly, when resource allocation is performed by the contiguous resource allocation region, the FH bit may be used for FH, and when resource allocation is performed by the non contiguous resource allocation region, the bit may be used to express an offset.

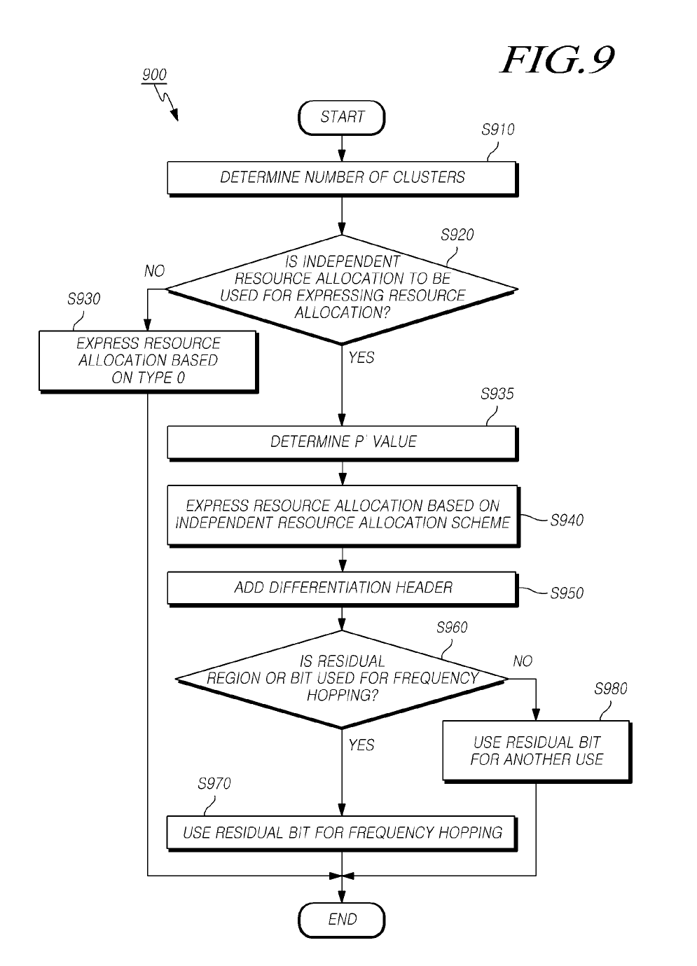

The method of expressing FH or another use in the residual portion of the resource allocation field has been described. Hereinafter, a resource allocation method will be described with reference to FIG. 9.

FIG. 9 illustrates a resource allocating method according to another embodiment of the present invention.

Referring to FIG. 9, a number of clusters may be determined (step S910). In this example, a maximum number of clusters may be defined to K, for example, 6. Resources may not be allocated to more than K+1 clusters. In other words, when the number of clusters is greater than or equal to K+1, resources may be allocated to K clusters.

Subsequently, whether to use an independent resource allocation scheme to indicate resource allocation may be determined (step S920). When the independent resource allocation scheme is a resource allocation scheme that has a range of clusters as described in the foregoing, step S920 may correspond to the range of clusters. When the independent resource allocation scheme is type 2, step 920 may perform determination based on a value of 1.

When the resource allocation is not based on the independent resource allocation scheme as a result of the determination of step S920, an LTE system may allocate resources based on the type 0 resource allocation scheme (step S930).

When the resource allocation is performed based on the independent resource allocation scheme as a result of the determination of step S920, a P′ value may be determined first (step S935). According to the LTE standard, a region that indicates the independent resource allocation scheme may have a relatively insufficient bit length, and thus, the P′ value may be adjusted and a number of expressible clusters may be limited.

Subsequently, resource allocation may be expressed based on the independent resource allocation scheme (step S940). When the independent resource allocation scheme is the type 2 resource allocation scheme in the LTE system, resources may be allocated based on the type 2 resource allocation scheme, that is, based on an offset and a length of a resource allocation region.

To express the independent resource allocation scheme, a differentiation header or a differentiation pattern may be added (step S950). When the maximum number of clusters is limited to K, for example, 6, as shown in the top of FIG. 6 and the top of FIG. 7, the differentiation header or the differentiation pattern of 11 bits of 10101010101 may be added to a predetermined location of a resource allocation field, for example, a header.

Subsequently, when a residual bit exists in the resource allocation field while the resource allocation is performed based on the independent resource allocation scheme, whether the residual bit is to be used for FH may be determined (step S960). A case in which the residual bit is used for FH may correspond to, for example, a case in which the number of clusters is 1, that is, a case of contiguous resource allocation. A case in which the residual bit is not used for FH may correspond to, for example, a case in which the number of clusters is two or more, that is, a case of noncontiguous resource allocation.

When the residual bit is used for FH as a result of the determination of step S960, whether to perform FH may be expressed in the residual bit that is an extra bit in addition to the bit length indicating the independent resource allocation scheme (step S970).

When the residual bit is not used for HB as a result of the determination of step S960, the residual bit that is an extra bit in addition to the bit length indicating the independent resource allocation scheme may be used for expressing another use (step S980). The other use may be an offset as shown in FIG. 8, but it may not be limited thereto. In this example, the residual bit may be used as an offset bit to express that resource allocation is performed by shifting, by a predetermined offset, RBs or RBGs to which resources are to be allocated.

Steps S950, S960, S970, and S980 may be omitted when the residual region or bit does not exist or is not used.

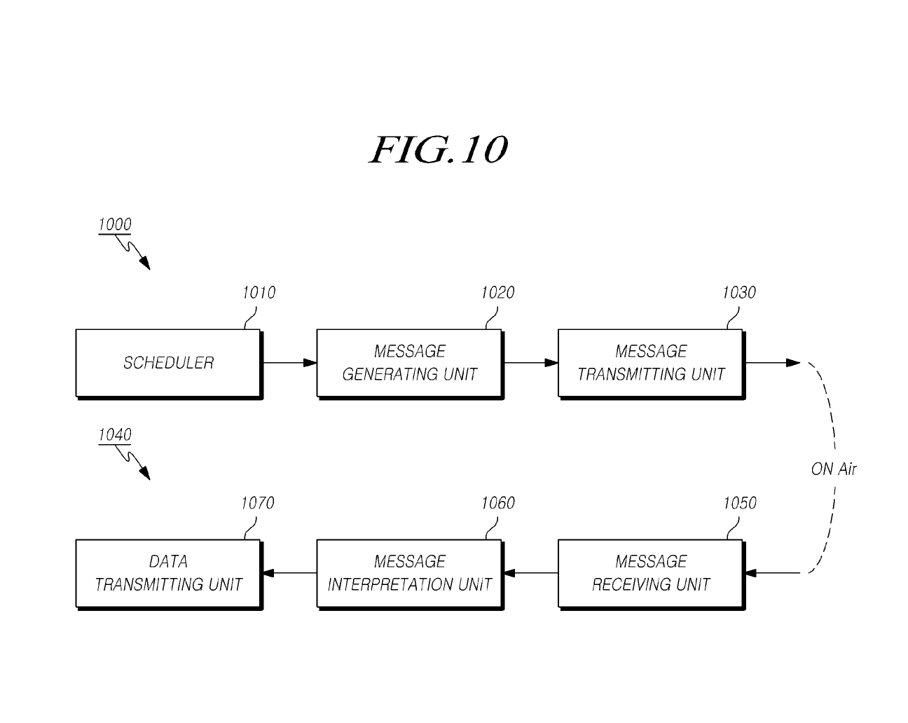

The resource allocation method has been described in the foregoing. Hereinafter, a wireless communication system will be described with reference to FIG. 10.

FIG. 10 illustrates a wireless communication system according to another embodiment of the present invention.

Referring to FIG. 10, the wireless communication system may include a resource allocation apparatus 1000 and a resource allocation receiving apparatus 1040.

The resource allocation apparatus 1000 may include a scheduler 1010, a message generating unit 1020, and a message transmitting unit 1030.

The scheduler 1010 may allocate resources to a predetermined UE. The message generating unit 1020 may generate a message that expresses resource allocation to the predetermined UE based on a different resource allocation scheme. As described in the foregoing, the resource allocation scheme may be one of a bitmap format-based resource allocation scheme corresponding to type 0 in an LTE system, a periodic resource allocation scheme corresponding to type 1 in the LTE system, a resource allocation scheme that expresses resource allocation based on a length and an offset of a resource allocation region corresponding to type 2 in the LTE system, and an independent resource allocation. According to another aspect of the embodiment, the resource allocation scheme may be a resource allocation scheme based on an RB unit or a resource allocation scheme based on an RBG unit corresponding to a set of RBs. For example, type 0 in the LTE system may correspond to a resource allocation scheme that allocates resources based on the RBG unit, and type 2 in the LTE system may correspond to a resource allocation scheme that allocates resources based on the RB unit or the RBG unit.

A method for the message generating unit 1020 to generate a message that expresses resource allocation to the predetermined UE based on a different resource allocation scheme and a structure of a resource allocation field may be the same as described in the foregoing. For example, the message generating unit 1020 may express the resource allocation scheme in a region excluding the resource allocation field of the message or a portion of the resource allocation field. Also, the message generated by the message generation unit 1020 may include the region that expresses the resource allocation scheme or a region that expresses resource allocation.

The portion of the resource allocation field may be a predetermined portion of the resource allocation field or a region that is expressed by bits in a predetermined pattern. For example, the portion of the resource allocation field may be a header of the resource allocation field, and resource allocation may be expressed in another portion of the resource allocation field.

Another portion of the resource allocation field may express FH or another use.

The message transmitting unit 1030 may transmit the message that is generated by the message generating unit 1020 to express resource allocation based on a different resource allocation scheme, to the resource allocation receiving apparatus 1040 on air. As described in the foregoing, the message may include, in control information, resource allocation information in a type of a predetermined resource allocation scheme based on a predetermined DCI format, and may wirelessly transmit the message to the resource allocation receiving apparatus 1040 through a PDCCH.

The resource allocation receiving apparatus 1040 may include a message receiving unit 1050, a message interpretation unit 1060, and a data transmitting unit 1070.

The message receiving unit 1050 may receive the message that expresses the resource allocation based on the different resource allocation scheme, which is wirelessly transmitted. As described in the foregoing, in the LTE system, the message receiving unit 1050 may receive the message that is included in the control information and transmitted through a control channel, for example, a PDCCH, from the resource allocation apparatus 1000.

The message interpretation unit 1060 may interpret the message based on the format of the message so as to obtain contents of the message. The message may include information associated with UL scheduling.

The data transmitting unit 1070 may transmit data in a UL, for example a data channel, based on information associated with UL scheduling obtained by the message interpretation unit 1060, when UL data transmission is performed.

The resource allocation receiving apparatus 1040 may additionally include a data receiving unit (not illustrated) that receives data in a DL data channel, based on information associated with DL scheduling obtained by the message interpretation unit 1060, when DL data reception is performed.

In terms of the method, the resource allocation receiving method may include a message receiving operation that receives a message that expresses resource allocation based on a different resource allocation scheme, which is wirelessly transmitted, a message interpreting operation that interprets the message based on a format of the message so as to obtain contents of the message, and a data transmitting operation that transmits data in a UL based on information associated with UL scheduling obtained through interpreting the message, in a UL data transmission process. In this example, the message may be received through a control channel in the message receiving operation, and the data may be transmitted through a data channel in the data transmitting operation. The resource allocation receiving method may additionally include a data receiving operation that receives data through a DL data channel based on information associated with DL scheduling obtained through interpretation of the message, in a DL data reception process.

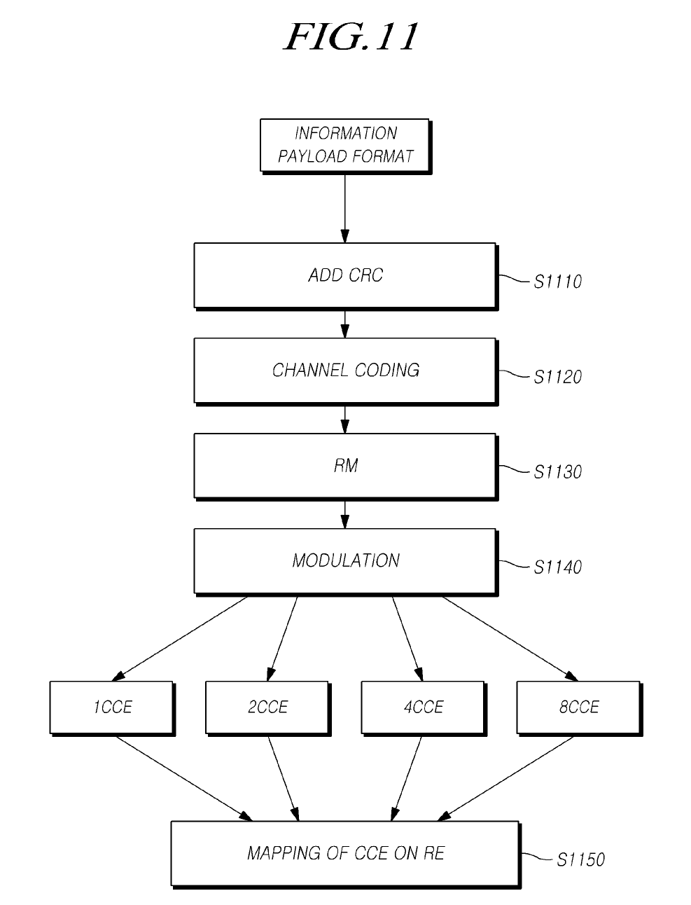

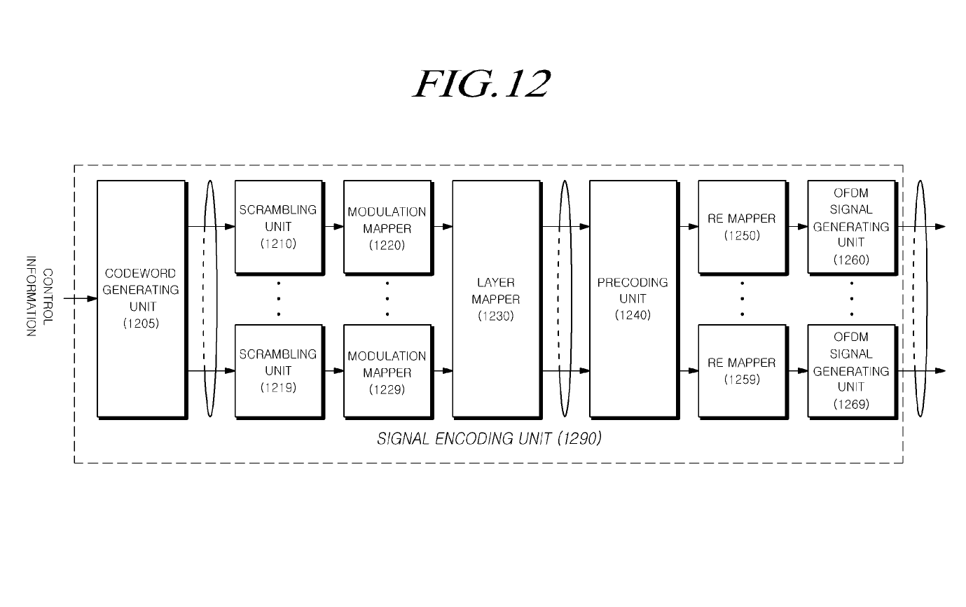

The wireless communication system has been described. Hereinafter, a configuration of the control channel in a physical layer, for example, a PDCCH, will be described with reference to FIGS. 11 and 12.

FIG. 11 illustrates a configuration of a PDCCH according to another embodiment of the present invention.

Referring to FIGS. 1 and 11, the BS 20 may form a PDCCH payload based on information payload format to be transmitted to a UE. A length of the PDCCH payload may be various based on the information payload format. The information payload format may be a DCI format.

In step S1110, a cyclic redundancy check (CRC) for error detection may be added to each PDCCH payload in step S1110. An identifier (referred to as a radio network temporary identifier (RNTI)) may be masked on the CRC based on an owner of a PDCCH or a use of a PDCCH.

In step S1120, coded data may be generated by performing channel coding of control information to which the CRC is added.

In step S1130, rate matching (RM) may be performed based on a CCE aggregation level allocated to a PDCCH format.

In step S1140, modulation symbols may be generated by modulating coded data.

In step S1150, modulation symbols may be mapped to a physical resource element (CCE to RE mapping).

FIG. 12 illustrates a BS that generates control information of a DL according to another embodiment of the present invention.

Referring to FIGS. 1 and 12, a codeword generating unit 1205, scrambling units 1210 through 1219, modulation mappers 1220 through 1229, a layer mapper 1230, a precoding unit 1240, resource element (RE) mappers 1250 through 1259, OFDM signal generating units 1260 through 1269 included in a signal encoding unit 1290 may exist as separate modules, or two or more of them may function as a single module.

Control information to which a CRC is added may be generated as an OFDM signal through the codeword generating unit 1205, the scrambling units 1210 through 1219, the modulation mappers 1220 through 1229, the layer mapper 1230, the precoding unit 1240, the RE mapper 1250 through 1259, and the OFDM signal generating unit 1260 through 1269, and may be transmitted to a UE through an antenna.

Precoding is omitted in a process of generating a PDCCH of FIG. 11 and thus, an input and an output of precoding may be the same in the OFDM signal generating process of FIG. 12. Also, after generating a codeword, the codeword may not go through a multi-path. To generate a PDCCH control channel, a tailbiting convolutional coding (TCC) may be used, and an operation associated with rate matching (RM) may be applicable.

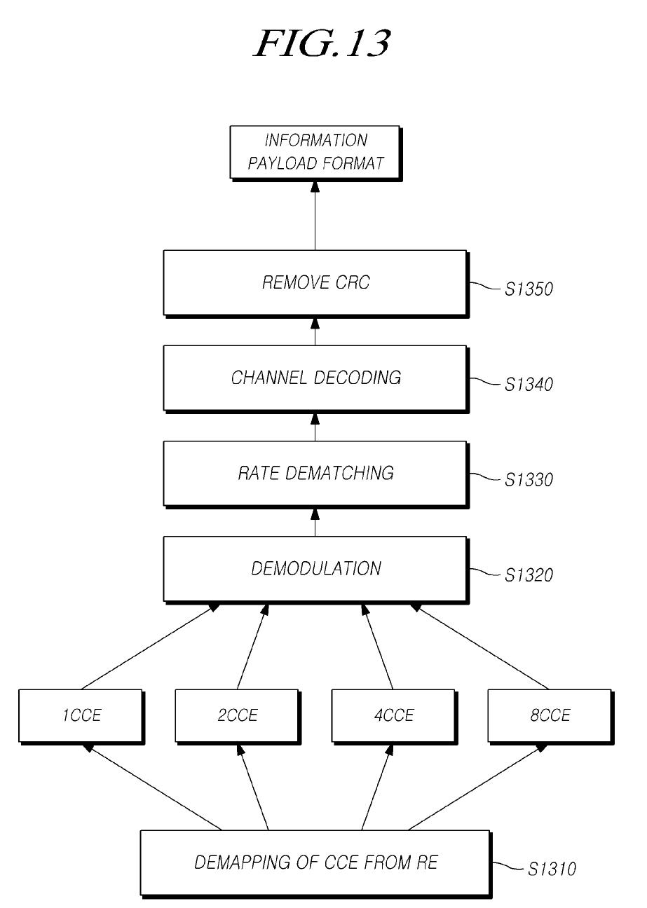

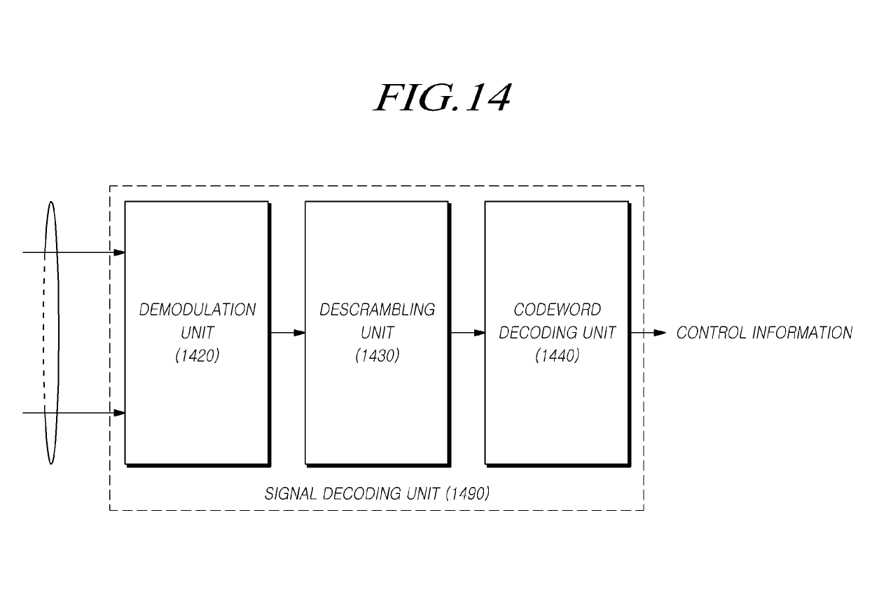

A configuration of a PDCCH in a physical layer has been described. Hereinafter, PDCCH processing in a physical layer will be described with reference to FIGS. 13 and 14.

FIG. 13 illustrates PDCCH processing.

Referring to FIGS. 1 and 13, in step S1310, the UE 10 may perform demapping of a CCE from a physical resource element (CCE to RE demapping).

In step S1320, the UE 10 may perform demodulation with respect to a CCE aggregation level that a payload corresponding to a reference DCI format associated with a transmission mode of the UE 10 may have, since the UE 10 is not aware of at which CCE aggregation level the UE 10 is to receive a PDCCH.

In step S1330, the UE 10 may perform rate dematching of the demodulated data based on the corresponding payload and the CCE aggregation level.

In step S1340, the UE 10 may perform channel-decoding of encoded data based on the code rate, and perform CRC so as to detect whether an error occurs. When an error is not detected, it indicates that the UE 10 detects a corresponding PDCCH. When an error occurs, the UE 10 may continuously perform blind decoding with respect to another CCE aggregation level or another DCI format.

In step S1350, the UE 10 that detects the corresponding PDCCH may remove a CRC from the decoded data so as to obtain control information required by the UE 10.

In particular, the UE 10 may detect DCI format 0 so as to interpret UL scheduling grant included in DCI format 0.

Also, the UE 10 may detect other DCI formats so as to perform functions of DL scheduling assignments and UL scheduling grant, DL scheduling assignments and UL scheduling grant of a corresponding component carrier (CC) that is identified by a CC indicator through use of power control command information, power controlling, and the like.

FIG. 14 illustrates a UE according to another embodiment of the present invention.

Referring to FIGS. 1 and 14, the UE may receive a signal from a BS via an antenna.

A demodulation unit 1420 may provide a function of performing demodulation of a received signal. When the BS transmits an OFDM signal, the demodulation unit 1420 may perform demodulation based on an OFDM scheme. In addition, based on whether the signal generated by the BS corresponds to an FDD scheme or a TDD scheme, the demodulation unit 1420 may perform demodulation according to a corresponding scheme.

The demodulated signal may be descrambled by a descrambling unit 1430 and thus, a codeword having a predetermined length may be generated. A codeword decoding unit 1440 may restore the codeword to be predetermined control information. The functions may be performed by a signal decoding unit 1490 at once, or may be performed by two or more modules independently or sequentially.

Although an exemplary embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method for a base station (BS) to allocate resources, the method comprising:
allocating resources to one or more user equipments (UEs) in a wireless communication system; and
generating a message that expresses, in a single resource allocation field, resource allocation to the one or more UEs through use of one of two or more different resource allocation schemes when the resource allocation is performed, and that expresses the resource allocation scheme in a portion of the resource allocation field or in a region excluding the resource allocation field.

2. The method as claimed in claim 1, wherein the message generated in the operation of generating the message includes a region expressing the resource allocation scheme or a region expressing the resource allocation.

3. The method as claimed in claim 1, wherein the resource allocation scheme corresponds to one of a bitmap format-based resource allocation scheme, a periodic resource allocation scheme, a resource allocation scheme that expresses resource allocation based on a length and an offset associated with a resource allocation region, and an independent resource allocation scheme.

4. The method as claimed in claim 3, wherein the resource allocation scheme is one of resource allocation type 0 of long term evolution (LTE) corresponding to the bitmap format-based resource allocation scheme and resource allocation type 2 of LTE corresponding to the resource allocation scheme that expresses resource allocation based on the length and the offset associated with the resource allocation region.

5. The method as claimed in claim 1, wherein the resource allocation scheme corresponds to a resource allocation scheme based on a resource block (RB) or a resource allocation scheme based on a resource block group (RBG) unit corresponding to a set of RBs.

6. The method as claimed in claim 1, wherein the portion of resource allocation field corresponds to a predetermined portion of the resource allocation field or a region expressed by bits in a predetermined pattern.

7. The method as claimed in claim 6, wherein the portion of the resource allocation field is a header of the resource allocation field, and resource allocation is expressed in another portion of the resource allocation field.

8. The method as claimed in claim 6, wherein another portion of the resource allocation field expresses frequency hopping (FH) or another use.

9. The method as claimed in claim 1, wherein the region excluding the resource allocation field further includes a separate frequency hopping (FH) region, and the FH region expresses whether to perform FH or expresses another use when the FH region does not express whether to perform FH.

10. A resource allocation apparatus, the apparatus comprising:
a scheduler to allocate resources to one or more user equipments (UEs);
a message generating unit to generate a message that expresses, in a single resource allocation field, resource allocation to the one or more UEs through use of one of two or more different resource allocation schemes, and that expresses the resource allocation scheme in a portion of the resource allocation field or a region excluding the resource allocation field; and
a message transmitting unit to transmit the message generated by the message generating unit.

11. The apparatus as claimed in claim 10, wherein the message generated by the message generating unit includes a region expressing the resource allocation scheme or a region expressing the resource allocation.

12. The apparatus as claimed in claim 10, wherein the resource allocation scheme corresponds to one of a bitmap format-based resource allocation scheme, a periodic resource allocation scheme, a resource allocation scheme that expresses resource allocation based on a length and an offset associated with a resource allocation region, and an independent resource allocation scheme.

13. The apparatus as claimed in claim 12, wherein the resource allocation scheme corresponds to one of resource allocation type 0 of long term evolution (LTE) corresponding to the bitmap format-based resource allocation scheme and resource allocation type 2 of LTE corresponding to the resource allocation scheme that expresses resource allocation based on the length and the offset associated with the resource allocation region.

14. The apparatus as claimed in claim 10, wherein the resource allocation scheme corresponds to a resource allocation scheme based on a resource block (RB) unit or a resource allocation scheme based on a resource block group (RBG) unit corresponding to a set of RBs.

15. The apparatus as claimed in claim 10, wherein the portion of resource allocation field corresponds to a predetermined portion of the resource allocation field or a region expressed by bits in a predetermined pattern.

16. The apparatus as claimed in claim 15, wherein the portion of the resource allocation field is a header of the resource allocation field, and resource allocation is expressed in another portion of the resource allocation field.

17. The apparatus as claimed in claim 15, wherein another portion of the resource allocation field expresses frequency hopping (FH) or another use.

18. The apparatus as claimed in claim 10, wherein the region excluding the resource allocation field further includes a separate long term evolution (FH) region, and the FH region expresses whether to perform FH or expresses another use when the FH region does not express whether to perform FH.

19. A resource allocation receiving apparatus, the apparatus comprising:
a message receiving unit to receive a wirelessly transmitted message that expresses, in a single resource allocation field, resource allocation to one or more user equipments (UEs) through use of one of the two or more different resource allocation schemes, and that expresses the resource allocation scheme in a portion of the resource allocation field or a region excluding the resource allocation field;
a message interpretation unit to interpret the message based on a format of the message to obtain contents of the message; and
a data transmitting unit to transmit data in an uplink (UL) based on information associated with UL scheduling obtained through the message interpretation unit when UL data transmission is performed.

20. The apparatus as claimed in claim 19, wherein the message receiving unit receives the message via a control channel, and the data transmitting unit transmits the data via a data channel.

21. A resource allocation receiving method, the method comprising:
receiving a wirelessly transmitted message that expresses, in a single resource allocation field, resource allocation to the one or more user equipments (UEs) through use of one of the two or more different resource allocation schemes, and that expresses the resource allocation scheme in a portion of the resource allocation field or a region excluding the resource allocation field;
interpreting the message based on a format of the message to obtain contents of the message; and
transmitting data in an uplink (UL) based on information associated with UL scheduling obtained through interpretation of the message when UL data transmission is performed.

22. The method as claimed in claim 21, wherein receiving of the message comprises receiving the message via a control channel; and
transmitting of the data comprises transmitting the data via a data channel.
